(19) United States
(12) Patent Application Publication
(10) Pub. No.: US 2024/0119361 A1
(43) Pub. Date: Apr. 11, 2024

(54) TECHNIQUES FOR HETEROGENEOUS CONTINUAL LEARNING WITH MACHINE LEARNING MODEL ARCHITECTURE PROGRESSION

(71) Applicant: NVIDIA CORPORATION, Santa Clara, CA (US)

(72) Inventors: Hongxu YIN, San Jose, CA (US); Wonmin BYEON, Santa Cruz, CA (US); Jan KAUTZ, Lexington, MA (US); Divyam MADAAN, Brooklyn, NY (US); Pavlo MOLCHANOV, Mountain View, CA (US)

(21) Appl. No.: 18/348,286

(22) Filed: Jul. 6, 2023

Related U.S. Application Data
(60) Provisional application No. 63/377,505, filed on Sep. 28, 2022.

(51) Int. Cl. G06N 20/00

(52) U.S. Cl. CPC G06N 20/00

(57) ABSTRACT

One embodiment of a method for training a first machine learning model having a different architecture than a second machine learning model includes receiving a first data set, performing one or more operations to generate a second data set based on the first data set and the second machine learning model, wherein the second data set includes at least one feature associated with one or more tasks that the second machine learning model was previously trained to perform, and performing one or more operations to train the first machine learning model based on the second data set and the second machine learning model.

### CROSS-REFERENCE TO RELATED APPLICATIONS

This application claims priority benefit of the United States Provisional patent application titled, “HETEROGENEOUS CONTINUAL LEARNING WITH NEURAL NETWORK ARCHITECTURE PROGRESSION,” filed on Sep. 28, 2022, and having Ser. No. 63/377,505. The subject matter of this related application is hereby incorporated herein by reference.

### BACKGROUND

### Technical Field

Embodiments of the present disclosure relate generally to computer science and machine learning and, more specifically, to techniques for heterogeneous continual learning with machine learning model architecture progression.

### Description of the Related Art

In machine learning, data is used to train machine learning models to perform various tasks. Oftentimes, new data becomes available after a machine learning model is trained. One approach for updating a previously trained machine learning model to account for new data is to re-train the previously trained machine learning model using a continual learning technique. As a general matter, conventional continual learning techniques update the weights of a previously trained machine learning model based on new data.

One drawback of conventional continual learning techniques, though, is that these techniques require the architecture of a previously trained machine learning model to remain the same when the previously trained machine learning model is re-trained using new data. For example, when a previously trained machine learning model is an artificial neural network, the aspects of the neural network architecture that need to remain the same include the number and types of neurons within the neural network as well as the topology of how those neurons are connected. Notably, because conventional continual learning techniques require the architecture of a previously trained machine learning model to remain the same, those conventional techniques cannot be used to transfer knowledge from a previously trained machine learning model to a second machine learning having a different architecture when training the second machine learning model using new data. Instead, the second machine learning model needs to be trained from scratch using the new data as well as the data that was used to train the previously trained machine learning model. Training the second machine learning model from scratch can, as a general matter, be computationally expensive and time consuming. In addition, because the second machine learning model also needs to be trained using the data that was used to train the previously trained machine learning model, storage space in some form is normally required to store all of the training data, often for long periods of time.

As the foregoing illustrates, what is needed in the art are more effective techniques for training machine learning models with different architectures.

### SUMMARY

One embodiment of the present disclosure sets forth a computer-implemented method for training a first machine learning model having a different architecture than a second machine learning model. The method includes receiving a first data set, and performing one or more operations to generate a second data set based on the first data set and the second machine learning model. The second data set includes at least one feature associated with one or more tasks that the second machine learning model was previously trained to perform. The method further includes performing one or more operations to train the first machine learning model based on the second data set and the second machine learning model.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques enable knowledge from a previously trained machine learning model to be transferred to a second machine learning having a different architecture when training the second machine learning model using new data. Further, with the disclosed techniques, the data used to train the previously trained machine learning model is not required to train the second machine learning model. In addition, with the disclosed techniques, the new data is optimized when training the second machine learning model, which is more computationally efficient than prior art approaches that optimize random noise. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a more detailed block diagram of the machine learning server of FIG. 1, according to various embodiments;

FIG. 3 illustrates how heterogeneous continual learning can be applied to train a machine learning model with architectural progression, according to various embodiments;

FIG. 4 illustrates how the model trainer of FIG. 1 performs heterogeneous continual learning, according to various embodiments;

FIG. 5 illustrates an exemplar synthesis of features associated with a previous task from new data associated with a current task, according to various embodiments; and

FIG. 6 is a flow diagram of method steps for performing heterogeneous continual learning to train a machine learning model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### GENERAL OVERVIEW

Embodiments of the present disclosure provide techniques for training a machine learning model using new data and a previously trained machine learning model having a different architecture. The disclosed techniques are also referred to herein as “heterogeneous continual learning.” In some embodiments, during heterogeneous continual learning, a model trainer performs an inversion using new data and a previously trained machine learning model to generate additional data that includes features associated with one or more tasks for which the previously trained machine learning model was trained. Then, the model trainer trains a new machine learning model having a different architecture than the previously trained machine learning model using the new data, the additional data, and the previously trained machine learning model (or using the previously trained machine learning model and the new data to which features associated with the one or more tasks for which the previously trained machine learning model was trained have been added). Training the new machine learning model includes optimizing an objective function that includes (1) a term used to minimize a distance between outputs of the new machine learning model and the previously trained machine learning model, and (2) a term used to ensure that the new machine learning model makes correct predictions given the new data (to which features associated with the one or more tasks for which the previously trained machine learning model was trained may have been added).

The techniques disclosed herein for training a machine learning model using heterogeneous continual learning have many real-world applications. For example, those techniques could be used to train a machine learning model that is deployed in an autonomous vehicle, a virtual assistant, a robot, a web application, or any other suitable application.

The above examples are not in any way intended to be limiting. As persons skilled in the art will appreciate, as a general matter, the techniques for training a machine learning model using heterogeneous continual learning can be implemented in any suitable application.

### System Overview

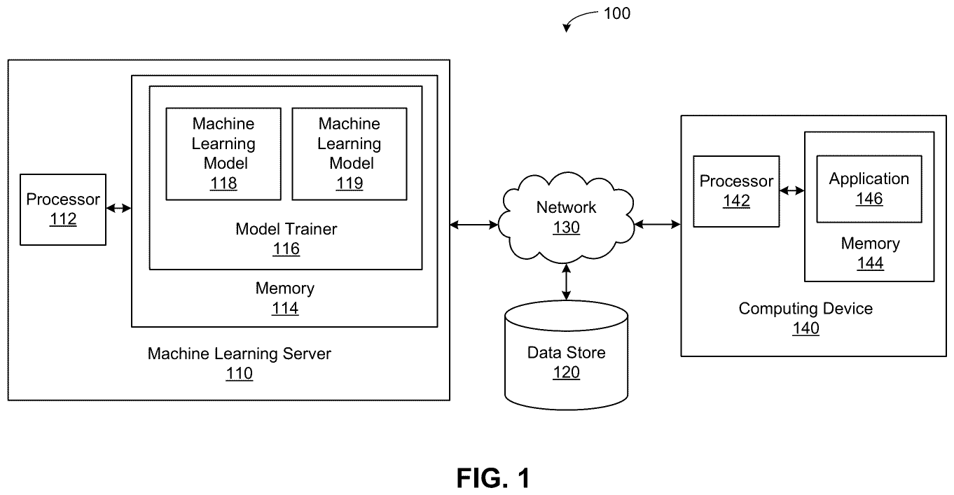

FIG. 1 is a block diagram illustrating a computer system 100 configured to implement one or more aspects of the various embodiments. As shown, the system 100 includes a machine learning server 110, a data store 120, and a computing device 140 in communication over a network 130, which can be a wide area network (WAN) such as the Internet, a local area network (LAN), or any other suitable network.

As shown, a model trainer 116 executes on a processor 112 of the machine learning server 110 and is stored in a system memory 114 of the machine learning server 110. The processor 112 receives user input from input devices, such as a keyboard or a mouse. In operation, the processor 112 is the master processor of the machine learning server 110, controlling and coordinating operations of other system components. In particular, the processor 112 can issue commands that control the operation of a graphics processing unit (GPU) (not shown) that incorporates circuitry optimized for graphics and video processing, including, for example, video output circuitry. The GPU can deliver pixels to a display device that can be any conventional cathode ray tube, liquid crystal display, light-emitting diode display, or the like.

The system memory 114 of the machine learning server 110 stores content, such as software applications and data, for use by the processor 112 and the GPU. The system memory 114 can be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, or any suitable combination of the foregoing.

It will be appreciated that the machine learning server 110 shown herein is illustrative and that variations and modifications are possible. For example, the number of processors 112, the number of GPUs, the number of system memories 114, and the number of applications included in the system memory 114 can be modified as desired. Further, the connection topology between the various units in FIG. 1 can be modified as desired. In some embodiments, any combination of the processor 112, the system memory 114, and a GPU can be replaced with any type of virtual computing system, distributed computing system, or cloud computing environment, such as a public, private, or a hybrid cloud.

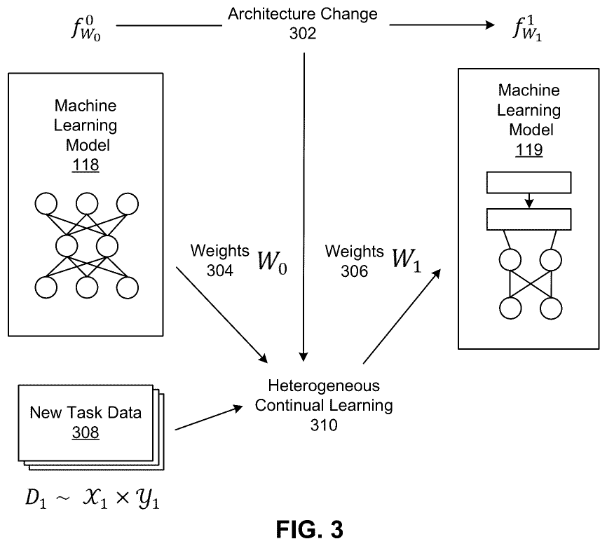

The model trainer 116 is configured to train one or more machine learning models, which can be artificial neural networks in some embodiments. In some embodiments, the model trainer 116 is configured to perform heterogeneous continual learning to train one or more machine learning models. Illustratively, the model trainer 116 can perform heterogeneous continual learning to train a machine learning model 119 using new data and a previously trained machine learning model 118 having a different architecture than the machine learning model 119. Techniques for performing heterogeneous continual learning are discussed in greater detail below in conjunction with FIGS. 3-6. Training data and/or trained machine learning models can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in some embodiments the machine learning server 110 can include the data store 120.

As shown, an application 146 utilizing the machine learning model 119 that has been trained using heterogeneous continual learning is stored in a memory 144, and executes on a processor 142, of the computing device 140. Once trained, machine learning models, such as the machine learning model 119, can be deployed, such as via the application 146, to perform any technically feasible task or tasks for which the machine learning models were trained. For example, in some embodiments, trained machine learning models can be deployed in autonomous vehicles, virtual assistants, robots, web applications, or any other suitable application.

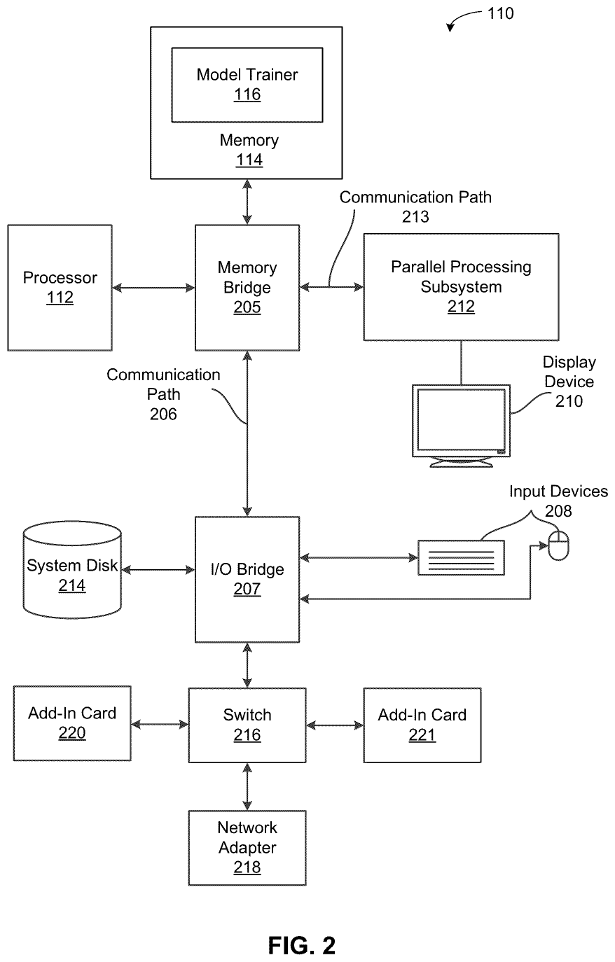

FIG. 2 is a more detailed block diagram of the machine learning server 110 of FIG. 1, according to various embodiments. As persons skilled in the art will appreciate, the machine learning server 110 can be any type of technically feasible computer system, including, without limitation, a server machine, a server platform, a desktop machine, laptop machine, a hand-held/mobile device, or a wearable device. In some embodiments, the machine learning server 110 is a server machine operating in a data center or a cloud computing environment that provides scalable computing resources as a service over a network. In some embodiments, the computing device 140 can include similar components as the machine learning server 110.

In various embodiments, the machine learning server 110 includes, without limitation, the processor 112 and the memory 114 coupled to a parallel processing subsystem 212 via a memory bridge 205 and a communication path 213. The memory bridge 205 is further coupled to an I/O (input/output) bridge 207 via a communication path 206, and the I/O bridge 207 is, in turn, coupled to a switch 216.

In some embodiments, the I/O bridge 207 is configured to receive user input information from optional input devices 208, such as a keyboard or a mouse, and forward the input information to the processor 112 for processing via the communication path 206 and the memory bridge 205. In some embodiments, the machine learning server 110 may be a server machine in a cloud computing environment. In such embodiments, the machine learning server 110 may not have input devices 208. Instead, the machine learning server 110 may receive equivalent input information by receiving commands in the form of messages transmitted over a network and received via the network adapter 218. In some embodiments, the switch 216 is configured to provide connections between the I/O bridge 207 and other components of the machine learning server 110, such as a network adapter 218 and various add-in cards 220 and 221.

In some embodiments, the I/O bridge 207 is coupled to a system disk 214 that may be configured to store content and applications and data for use by the processor 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, communication paths 206 and 213, as well as other communication paths within the machine learning server 110, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. Such circuitry may be incorporated across one or more parallel processing units (PPUs), also referred to herein as parallel processors, included within the parallel processing subsystem 212. In other embodiments, the parallel processing subsystem 212 incorporates circuitry optimized for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and compute processing operations. The system memory 114 includes at least one device driver configured to manage the processing operations of the one or more PPUs within the parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In various embodiments, the parallel processing subsystem 212 may be integrated with one or more of the other elements of FIG. 2 to form a single system. For example, the parallel processing subsystem 212 may be integrated with the processor 112 and other connection circuitry on a single chip to form a system on chip (SoC).

In some embodiments, the processor 112 is the master processor of the machine learning server 110, controlling and coordinating operations of other system components. In some embodiments, the processor 112 issues commands that control the operation of PPUs. In some embodiments, the communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, the system memory 114 could be connected to processor 112 directly rather than through the memory bridge 205, and other devices would communicate with system memory 114 via the memory bridge 205 and the processor 112. In other embodiments, the parallel processing subsystem 212 may be connected to the I/O bridge 207 or directly to the processor 112, rather than to the memory bridge 205. In still other embodiments, the I/O bridge 207 and the memory bridge 205 may be integrated into a single chip instead of existing as one or more discrete devices. In certain embodiments, one or more components shown in FIG. 2 may not be present. For example, the switch 216 could be eliminated, and the network adapter 218 and the add-in cards 220, 221 would connect directly to the I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 could be implemented as a virtual graphics processing unit (GPU) that renders graphics on a virtual machine (VM) executing on a server machine whose GPU and other physical resources are shared across multiple VMs.

### Heterogeneous Continual Learning with Machine Learning Model Architecture Progression

FIG. 3 illustrates how heterogeneous continual learning can be applied to train a machine learning model with architectural progression, according to various embodiments. As shown, a heterogeneous continual learning technique 310 is applied to train a machine learning model 119 that includes an architecture, denoted by f_{W}_{₁}¹, using (1) a previously trained machine learning model 118 that includes a different architecture, denoted by f_{W}_{₀}⁰, (shown as architecture change 302), and (2) new task data 308. For example, the machine learning model 119 could have an architecture that provides improved performance after training relative to an architecture of the machine learning model 118. In some embodiments, the new task data 308 includes data associated with one or more new tasks that the machine learning model 119 is trained to perform, but that the machine learning model 118 was not trained to perform. Training the machine learning model 119 using such data associated with one or more new tasks that the machine learning model 118 was not trained to perform is also referred to herein as task-incremental (task-IL) training. In some embodiments, the new task data 308 includes data that is associated with one or more new tasks that the machine learning model 119 is to be trained to perform, and that the machine learning model 118 was previously trained to perform. Training the machine learning model 119 using such data associated with one or more new tasks that the machine learning model 118 was also trained to perform is also referred to herein as data-incremental (data-IL) training. Illustratively, the new task data 308 and weights 304 of the previously trained machine learning model 118, which are denoted by W₀, are required by the heterogeneous continual learning technique 310 to train the machine learning model 119 and update weights 306 thereof, which are denoted by W₁.

In some embodiments, the heterogeneous continual learning technique 310 includes (1) performing a quick deep inversion of the new task data 308 using the previously trained machine learning model 118 to generate additional data (not shown), and (2) training the machine learning model 119 using the new task data 308, the additional data, and the previously trained machine learning model 118. Although described herein primarily with respect to training the machine learning model 119 using the new task data 308, the additional data, and the previously trained machine learning model 118, in some embodiments, the machine learning model 119 can be trained using (1) new task data to which features have been added using quick deep inversion and (2) the previously trained machine learning model 118. That is, data generated using quick deep inversion can either be used independently or jointly with the new task data 302 to train the machine learning model 118.

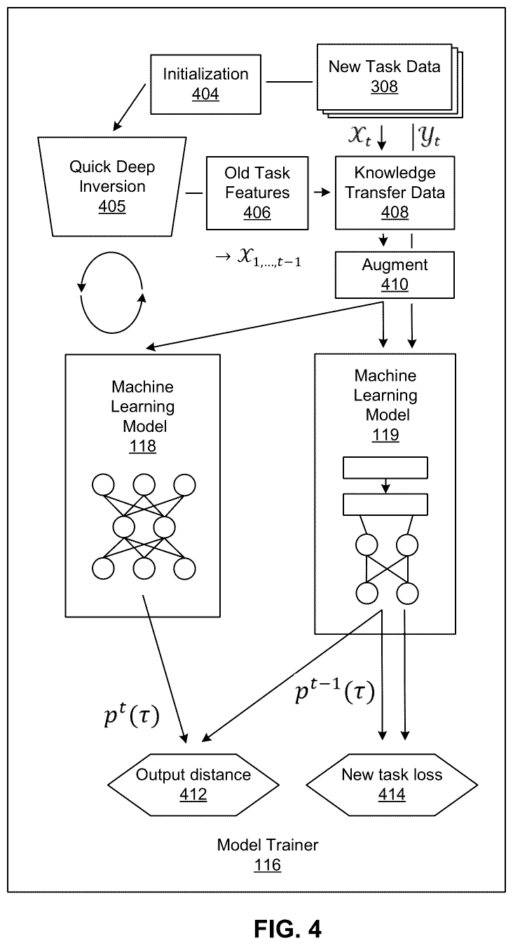

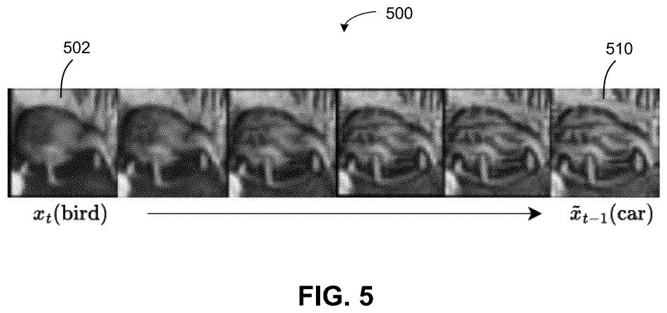

During quick deep inversion, the previously trained machine learning model 118 provides teacher guidance to synthesize features associated with previous data that was used to train the previously trained machine learning model 118 to perform one or more tasks, which the previously trained machine learning model 118 has memorized. Accordingly, domain knowledge associated with the one or more tasks for which the previously trained machine learning model 118 was trained to perform can be preserved. Notably, however, the previous data that was used to train the previously trained machine learning model 118 does not need to be stored or used to train the machine learning model 119. In some embodiments, the quick deep inversion technique is initialized using the new task data 308 rather than random noise, which is what conventional inversion techniques are initialized with. Details of such a quick deep inversion technique are discussed in greater detail below in conjunction with FIGS. 4-5.

In some embodiments, training of the new machine learning model 119 includes optimizing an objective function that includes (1) a first term used to minimize a distance between outputs of the machine learning model 119 and the previously trained machine learning model 118, thereby encouraging the machine learning model 119 to produce a same output distribution as the previously trained machine learning model 118; and (2) a second term used to ensure that the machine learning model 119 makes correct predictions given the new task data 308 (to which features associated with previous data that was used to train the previously trained machine learning model 118 may have been added). The first term, which is used to minimize the distance between outputs of the machine learning model 119 and the previously trained machine learning model 118, distills knowledge from the previously trained machine learning model 118, acting as a teacher model, to the machine learning model 119, acting as a student model. Accordingly, the machine learning model 119 does not forget what was learned by the previously trained machine learning model 118. Experience has shown that, in some embodiments, knowledge can be distilled from relatively weak teacher models to relatively strong student models, such as student models having architectures that provide improved performance relative to architectures of the teacher models. The second term is used to ensure that the machine learning model 119 makes correct predictions given the new task data 308. Accordingly, the machine learning model 119 is able to learn new knowledge based on the new task data 308 that the previously trained machine learning model 118 was not trained on.

More formally, the problem of conventional continual learning is a learning objective where the continual learning f_{Wt}:Xₜ→ [symbol] ₜ learns a sequence of T tasks by updating the fixed representation structure for each task. Each task t∈T includes training data Dt={xᵢ, yᵢ}ᵢ₌₁^{N}^{ₜ}˜Xₜ× [symbol] ₜ, which is composed of Nₜ identically and independently distributed examples. In some embodiments, the heterogeneous continual learning technique 310 minimizes the following objective:

$${minimize}_{{W}_{t}} {𝔼}_{( {x}_{i} , {y}_{i} ) ∼ {D}_{t}} [ ℓ ( fWt ( {x}_{i} ) , {y}_{i} ) ] , \qquad ( 1 )$$

where [symbol] : [symbol] t× [symbol] t→ [symbol] ≥0 is the task-specific loss function. Specifically, the continual learning is a stream of architectures {f_{W}_{₁}¹, . . . , f_{W}_{ₜ}^{t}}, where the learner can completely change the backbone architecture to, e.g., incorporate recent architectural developments to improve performance. However, when the architectures are different, such as the different architectures of machine learning models 118 and 119, there is no natural knowledge transfer mechanism, especially if parameters of the machine learning models are initialized randomly. Particularly, each architectural representation f_{W}_{ₜ}^{t}: Xt→ [symbol] t, ∀t∈{1, . . . , T} is trained on a task distribution Dₜ, and the objective of the heterogeneous continual learning technique 310 is to train the stream of machine learning models on a sequence of tasks without forgetting the knowledge of the previous set of tasks. Additionally, when the structure of the machine learning models remains the same, the learned representations should transfer sequentially to train incoming tasks. Overall, the learning objective of the heterogeneous continual learning technique 310 is:

$${minimize}_{{W}_{t}} {𝔼}_{( {x}_{i} , {y}_{i} ) ∼ {D}_{t}} [ ℓ ( {f}_{{W}_{t}}^{t} ( {x}_{i} ) , {y}_{i} ] . \qquad ( 2 )$$

For simplicity of notation, the Wₜ will be discarded in f_{W}_{ₜ}^{t} hereinafter. In some embodiments, the heterogeneous continual learning technique 310 does not rely on task identifiers during training and uses constant memory. As described, task-IL and data-IL training can be performed in some embodiments. Further, task labels are not required during training in some embodiments. In task-IL training, new data can be used to train a machine learning model to perform new tasks, such as predicting new classes of objects. In data-IL training, new data can be used to train a machine learning model to better perform tasks that a previously trained machine learning model was also trained to perform, such as predicting the same classes of objects. In some embodiments, in task-IL training, the task identity is provided to select a classification head, whereas in data-IL training, a shared head is used across all classes. In such cases, data-IL can be more challenging due to an equal weight for all the tasks, and data-IL can be more prone to higher levels of forgetting and lower accuracy than task-IL. Although described herein with respect to classification as a reference example of tasks that machine learning models can be trained to perform, in some embodiments, machine learning models having any technically feasible architecture can be trained to perform any suitable tasks, such as regression, semantic segmentation, anomaly detection, etc., using the techniques disclosed herein.

FIG. 4 illustrates how the model trainer 116 of FIG. 1 performs heterogeneous continual learning, according to various embodiments. As shown, the model trainer 116 uses the new task data 308 to initialize (shown as initialization 404) a quick deep inversion technique 405 that adds old task features 406, which are associated with one or more tasks that the previously trained machine learning model 118 was trained to perform, to the new task data 308 in order to generate knowledge transfer data 408. In some embodiments, the knowledge transfer data 408 includes (1) the new task data 308, and (2) modifications thereof in which the old task features 406 have been added via the quick deep inversion technique 405. In some embodiments, the knowledge transfer data 408 includes only modified new task data to which the old task features 406 have been added via the quick deep inversion technique 405. That is, data generated using quick deep inversion can either be used independently or jointly with the new task data 308 to train the machine learning model 118. In some embodiments, the quick deep inversion technique 405 includes backpropagating, through the previously trained machine learning model 118, gradients to the new task data 308 based on one or more tasks that the previously trained machine learning model 118 was trained to perform, thereby adding features associated with the one or more tasks to the new task data 308. For example, in some embodiments, the quick deep inversion technique 405 can iteratively optimize the new task data 308 to minimize a prediction loss on previous task(s) for which the previously trained machine learning model 118 was trained. Experience has shown that, because the quick deep inversion technique 405 is initialized using the new task data 308 rather than random noise, the quick deep inversion technique 405 can be more computationally efficient than conventional inversion techniques that are initialized using random noise. Details of the quick deep inversion technique for image processing tasks are discussed in greater detail below in conjunction with FIG. 5.

Illustratively, the model trainer 116 also augments 410 the knowledge transfer data 408 generated via the quick deep inversion technique 405. In some embodiments, to improve the knowledge distillation paradigm for heterogeneous continual learning, consistency and augmentation can be incorporated into the knowledge distillation paradigm for continual learning. Specifically, fixed teaching and distillation without augmentation can lead to overfitting of the machine learning model 119 on the current task performance. On the contrary, consistent teaching using the same input data for the machine learning model 119 (i.e., the student) and the previously trained machine learning model 118 (i.e., the teacher) and augmentation can improve generalization while reducing forgetting. In contrast to conventional knowledge distillation, the current task instances are used for distillation in some embodiments, as previous task data may be unavailable due to, e.g., data privacy and/or legal restrictions. In some embodiments, any technically feasible data augmentation(s) can be applied to the knowledge transfer data 408, and the specific data augmentation(s) that are applied will generally depend on the type of knowledge transfer data 408. For example, when the knowledge transfer data 408 includes images, the data augmentation(s) can include spatial transformations, rotations, color changes, randomly resized croppings, color jittering, cropmixes, etc. to enhance data diversity.

In some embodiments in which the tasks are classification tasks, the model trainer 116 can also perform label smoothing to produce better soft targets for knowledge distillation. Doing so can improve the knowledge transfer from a smaller model architecture to a larger model architecture and reduce the forgetting of knowledge.

Subsequent to augmenting 410 the knowledge transfer data 408, the model trainer 116 trains the machine learning model 119 using the augmented knowledge transfer data and the previously trained machine learning model 118. As shown, training the new machine learning model 119 includes optimizing an objective function that includes (1) an output distance term 412 that is used to minimize a distance between outputs of the machine learning model 119 and the previously trained machine learning model 118, and (2) a new task loss term 414 that is used to ensure that the machine learning model 119 makes correct predictions for any new tasks associated with the new task data 308 (which, in some embodiments, can include old task features that have been added quick deep inversion). In some embodiments, the output distance term 412 is a Kullback-Leibler (KL) divergence between logits, and in particular temperature-scaled output probabilities, of the machine learning model 119 and the previously trained machine learning model 118, and the new task loss term 414 is a soft cross entropy. In such cases, the overall objective can be:

$${minimize}_{{W}_{t}} {𝔼}_{( {x}_{i} , {y}_{i} ) ∼ {D}_{t}} [ ℓ ( {f}^{t} ( {x}_{i} ) , {y}_{i}^{t} ( ψ ) ) ] + α \cdot KL ( {p}_{i}^{t} ( τ ) , {p}_{i}^{t - 1} ( τ ) ) , \qquad ( 3 )$$

where yᵢ^{t}(ψ)=y(1−ψ)+ψ/C, ψ denotes the mixture parameter to interpolate the hard targets to uniform distribution defined using ψ, C is the number of classes, p^{t}(τ) and pᵢ^{t-1}(τ) denote the temperature-scaled output probabilities for current task model and past-task model, respectively, τ is the corresponding temperature, and a is a hyperparameter that controls the strength of the knowledge distillation loss. In some other embodiments, the output distance term 412 can include a mean squared error, a Jensen-Shannon divergence, or any other measure of distance between outputs of the machine learning model 119 and the previously trained machine learning model 118. In addition, in some embodiments, the new task loss term 414 can include a cross entropy, a binary cross entropy, or any other loss that can be used to train the new machine learning model to make correct predictions given new task data.

FIG. 5 illustrates an exemplar synthesis of features associated with a previous task from new data associated with a current task, according to various embodiments. As shown, an image 502 that is associated with the new task of predicting birds can be processed via the quick deep inversion technique, described above in conjunction with FIGS. 3-4, to generate another image 510 that is associated with a previous task of predicting cars, which a previously trained machine learning model was trained to perform. In some embodiments, performing the quick deep inversion technique can include backpropagating, through the previously trained machine learning model, gradients to the image 502 after providing the previously trained learning model with a car label. In some embodiments, the quick deep inversion technique iteratively optimizes the image 502 by making pixel-wise updates to the image 502 to minimize a prediction loss on the previous task of predicting cars by penalizing classifications that are not the car, such that the previously trained machine learning model predicts a car for the optimized image. Illustratively, after a number of iterations of the quick deep inversion technique, an optimized image 510 is generated that includes synthesized features associated with cars and, when input into the previously trained machine learning model, causes the previously trained machine learning model to output a prediction of a car. Notably, the image 510 includes an interpolation between the current task of predicting birds and the previous task of predicting cars, which can promote current task adaptation while minimizing catastrophic forgetting. In some embodiments, the quick deep inversion technique can be performed in parallel for multiple images in a batch of new images by changing the labels associated with the new images to previous labels associated with tasks that a previously trained machine learning model was trained to perform, and updating the new images to include features associated with the previous labels.

More formally, in some embodiments in which a new machine learning model and a previously trained machine learning model perform image classification tasks, the objective of optimization can be to excite particular features, or classes from previous tasks, and the optimization is guided by proxy image prior: (i) total variation [symbol] ₜᵥ, (ii) of the generated samples [symbol] , and (iii) feature distribution regularization [symbol] _{feature}. In such cases, the quick deep inversion technique initializes synthetic examples with the current task data prior to optimization. The current task samples are then optimized such that features will fall to the manifold learned by the previously trained machine learning model and the domain shift is minimized. The resulting images, such as the image 510, are classified as past task classes. The quick deep inversion technique generates examples \tilde{x}ₚᵣᵢₒᵣ{f^{t-1}, k} to approximate features from all previous tasks {1, . . . , t−1} by inverting the last machine learning model f^{t-1} with k optimization steps:

$${\tilde{x}}_{prior} \{ {f}^{t - 1} , k \} = {arg min}_{\tilde{x}} ℒ ( {f}^{t - 1} ( \tilde{x} ) , \tilde{y} ) + {α}_{tv} {ℒ}_{tv} ( \tilde{x} ) + {α}_{{ℓ}_{2}} {ℒ}_{{ℓ}_{2}} ( \tilde{x} ) + {α}_{feature} {ℒ}_{feature} , \qquad ( 4 )$$

where the synthesized examples are optimized towards prior classes \tilde{y}˜Y_{{1, . . . ,t-1}} to minimize forgetting. In equation (4), αₜᵥ, [symbol] , and α_{feature} denote hyper-parameters that determine the strength of individual losses. To improve synthesis speed, each image \tilde{x} can be initialized with current task input image xₜ, which experience has shown can provide a four times speed-up and lead to more natural images:

\tilde{x}ₚᵣᵢₒᵣ{f^{t-1},0}=\tilde{x}_{prior,k=0}=xₜ.

The initialized \tilde{x}ₚᵣᵢₒᵣ can be optimized using equation (5), regularized for realism by the target model f^{t-1}, and hence quickly unveil previous task visual features on top of the current task image through

$${ℒ}_{feature} = {\sum }_{l ∈ L} [ d ( {μ}_{l} ( {\tilde{x}}_{prior} ) , 𝔼 [ {μ}_{l} ( x ) \vert x ∼ {𝒳}_{\{ 1 , ... , t - 1 \}} ] ) + d ( {σ}_{l} ( {\tilde{x}}_{prior} ) , 𝔼 [ {σ}_{l} ( x ) \vert x ∼ {X}_{\{ 1 , ... , t - 1 \}} ] ) ] . \qquad ( 5 )$$

In equation (5), d(⋅,⋅) denotes the distance metric for feature regularization. In some embodiments, the distance metric used can be the mean-squared distance. In addition, a Gaussian distribution can be assumed for feature maps so that the focus is on batch-wise mean μₗ(x) and variance σₗ(x) for the layer l. It should be noted that these statistics are implicitly captured through the batch normalization in f^{t-1} without storing input data for all previous tasks {1, . . . , t−1}:E [μₗ(x)|x˜X_{{1, . . . ,t-1}}]≈BNₗ (running mean), E[σₗ(x)|x˜X_{{1, . . . ,t-1}}]≈BNₗ (running variance). Otherwise, these statistics can be approximated using values calculated with post-convolution feature maps given a current task batch to the target model, f^{t-1}, leveraging the feature extraction capability of the target model for previous tasks. The quick deep inversion technique permits continual learning with minimal additional cost, and the learning objective in equation (3) can be updated as:

$${minimize}_{{W}_{t}} {𝔼}_{( {x}_{i} , {y}_{i} ) ∼ {D}_{t}} [ ℓ ( {f}^{t} ( {x}_{i} ) , {y}_{i}^{t} ( ψ ) ) ] + α \cdot KL ( {p}_{i}^{t} ( τ ) , {p}_{i}^{t - 1} ( τ ) ) + β \cdot KL ( {\tilde{p}}_{i}^{t} ( τ ) , {\tilde{p}}_{i}^{t - 1} ( τ ) ) , \qquad ( 6 )$$

where \tilde{p}^{t}(τ) and \tilde{p}^{t-1}(τ) are the output probabilities of the generated examples scaled with temperature τ using the current and past task-models, and β is a hyper-parameter to control the strength of quick deep inversion distillation loss. As previously noted, experience has shown that the quick deep inversion technique can provide a four times speed-up relative to prior data inversion techniques, due to the current task being a better prior than pixel-wise Gaussian noise to learn generated data.

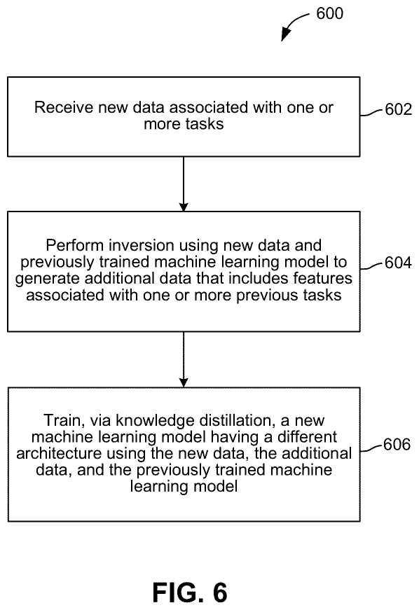

FIG. 6 is a flow diagram of method steps for performing heterogeneous continual learning to train a machine learning model, according to various embodiments. Although the method steps are described in conjunction with the systems of FIGS. 1-2, persons skilled in the art will understand that any system configured to perform the method steps in any order falls within the scope of the present embodiments.

As shown, a method 600 begins at step 602, where the model trainer 116 receives new data associated with one or more tasks. The new data can be associated with task(s) that a previously trained machine learning model was trained to perform and/or new task(s) that the previously trained machine learning model was not trained to perform.

At step 604, the model trainer 116 performs an inversion using the new data and the previously trained machine learning model to generate additional data that includes features associated with one or more tasks for which the previously trained machine learning model was trained. In some embodiments, the model trainer 116 can perform the quick deep inversion technique that is initialized using the new data to generate the additional data, as described above in conjunction with FIGS. 3-5. In some other embodiments, the model trainer 116 can perform an inversion technique that is initialized using random noise to generate the additional data.

At step 606, the model trainer 116 trains, via knowledge distillation, a new machine learning model, which includes a different architecture than the previously trained machine learning model, using the new data, the additional data, and the previously trained machine learning model. In some embodiments, the new machine learning model is trained via backpropagation with gradient descent, and the training optimizes an objective function that includes a term used to minimize a distance between outputs of the new machine learning model and the previously trained machine learning model, and another term used to ensure that the new machine learning model makes correct predictions on the new data, such as performing one or more new tasks to which the new data is associated. As described, in some other embodiments, a new machine learning model can be trained using (1) new data to which features have been added using quick deep inversion and (2) the previously trained machine learning model, because data generated using quick deep inversion can either be used independently or jointly with new data to train the machine learning model.

In sum, techniques are disclosed for performing heterogeneous continual learning to train a machine learning model using new data and a previously trained machine learning model having a different architecture. In some embodiments, a model trainer performs an inversion using new data and a previously trained machine learning model to generate additional data that includes features associated with one or more tasks for which the previously trained machine learning model was trained. Then, the model trainer trains a new machine learning model having a different architecture than the previously trained machine learning model using the new data, the additional data, and the previously trained machine learning model (or using the previously trained machine learning model and the new data to which features associated with the one or more tasks for which the previously trained machine learning model was trained have been added). Training the new machine learning model includes optimizing an objective function that includes (1) a term used to minimize a distance between outputs of the new machine learning model and the previously trained machine learning model, and (2) a term used to ensure that the new machine learning model makes correct predictions given the new data (to which features associated with the one or more tasks for which the previously trained machine learning model was trained may have been added).

At least one technical advantage of the disclosed techniques relative to the prior art is that the disclosed techniques enable knowledge from a previously trained machine learning model to be transferred to a second machine learning having a different architecture when training the second machine learning model using new data. Further, with the disclosed techniques, the data used to train the previously trained machine learning model is not required to train the second machine learning model. In addition, with the disclosed techniques, the new data is optimized when training the second machine learning model, which is more computationally efficient than prior art approaches that optimize random noise. These technical advantages represent one or more technological improvements over prior art approaches.

1. In some embodiments, a computer-implemented method for training a first machine learning model having a different architecture than a second machine learning model comprises receiving a first data set, performing one or more operations to generate a second data set based on the first data set and the second machine learning model, wherein the second data set includes at least one feature associated with one or more tasks that the second machine learning model was previously trained to perform, and performing one or more operations to train the first machine learning model based on the second data set and the second machine learning model.

2. The computer-implemented method of clause 1, wherein performing the one or more operations to train the first machine learning model comprises optimizing a loss function that includes a first term that minimizes a distance between an output of the first machine learning model and an output of the second machine learning model and a second term used to train the first machine learning model to perform one or more tasks that the second machine learning model was not previously trained to perform.

3. The computer-implemented method of clauses 1 or 2, wherein the first term comprises a Kullback-Leibler (KL) divergence, and the second term comprises a soft cross entropy.

4. The computer-implemented method of any of clauses 1-3, further comprising performing one or more operations to augment the second data set based on one or more data augmentations.

5. The computer-implemented method of any of clauses 1-4, wherein the first data set is associated with at least one task that is not included in the one or more tasks that the second machine learning model was previously trained to perform.

6. The computer-implemented method of any of clauses 1-5, wherein the first data set is associated with at least one task that is included in the one or more tasks that the second machine learning model was previously trained to perform.

7. The computer-implemented method of any of clauses 1-6, wherein performing one or more operations to generate the second data set comprises backpropagating one or more gradients to the first data set based on the one or more tasks that the second machine learning model was previously trained to perform.

8. The computer-implemented method of any of clauses 1-7, wherein the first data set does not include random noise.

9. The computer-implemented method of any of clauses 1-8, wherein the one or more operations to train the first machine learning model are further based on the first data set.

10. The computer-implemented method of any of clauses 1-9, further comprising performing one or more tasks using the first machine learning model subsequent to performing the one or more operations to train the first machine learning model.

11. In some embodiments, one or more non-transitory computer-readable media storing instructions that, when executed by at least one processor, cause the at least one processor to perform steps for training a first machine learning model having a different architecture than a second machine learning model, the steps comprising receiving a first data set, performing one or more operations to generate a second data set based on the first data set and the second machine learning model, wherein the second data set includes at least one feature associated with one or more tasks that the second machine learning model was previously trained to perform, and performing one or more operations to train the first machine learning model based on the second data set and the second machine learning model.

12. The one or more non-transitory computer-readable media of clause 11, wherein performing the one or more operations to train the first machine learning model comprises optimizing a loss function that includes a first term that minimizes a distance between an output of the first machine learning model and an output of the second machine learning model and a second term used to train the first machine learning model to perform one or more tasks that the second machine learning model was not previously trained to perform.

13. The one or more non-transitory computer-readable media of clauses 11 or 12, wherein the first term comprises one of a Kullback-Leibler (KL) divergence, a mean squared error, or a Jensen-Shannon divergence.

14. The one or more non-transitory computer-readable media of any of clauses 11-13, wherein the second comprises one of a cross entropy, a soft cross entropy, or a binary cross entropy.

15. The one or more non-transitory computer-readable media of any of clauses 11-14, wherein the first data set is associated with at least one task that is included in the one or more tasks that the second machine learning model was previously trained to perform.

16. The one or more non-transitory computer-readable media of any of clauses 11-15, wherein performing one or more operations to generate the second data set comprises backpropagating one or more gradients to the first data set based on the one or more tasks that the second machine learning model was previously trained to perform.

17. The one or more non-transitory computer-readable media of any of clauses 11-16, wherein the first data set includes one or more images.

18. The one or more non-transitory computer-readable media of any of clauses 11-17, wherein the one or more operations to train the first machine learning model are further based on the first data set.

19. The one or more non-transitory computer-readable media of any of clauses 11-18, wherein the steps further comprise performing one or more tasks using the first machine learning model subsequent to performing the one or more operations to train the first machine learning model.

20. In some embodiments, a system comprises one or more memories storing instructions, and one or more processors that are coupled to the one or more memories and, when executing the instructions, are configured to receive a first data set, perform one or more operations to generate a second data set based on the first data set and a first machine learning model, wherein the first machine learning model has a different architecture than a second machine learning model, and the second data set includes at least one feature associated with one or more tasks that the first machine learning model was previously trained to perform, and perform one or more operations to train the second machine learning model based on the second data set and the first machine learning model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a first machine learning model having a different architecture than a second machine learning model, the method comprising:
receiving a first data set;
performing one or more operations to generate a second data set based on the first data set and the second machine learning model, wherein the second data set includes at least one feature associated with one or more tasks that the second machine learning model was previously trained to perform; and
performing one or more operations to train the first machine learning model based on the second data set and the second machine learning model.

2. The computer-implemented method of claim 1, wherein performing the one or more operations to train the first machine learning model comprises optimizing a loss function that includes a first term that minimizes a distance between an output of the first machine learning model and an output of the second machine learning model and a second term used to train the first machine learning model to perform one or more tasks that the second machine learning model was not previously trained to perform.

3. The computer-implemented method of claim 2, wherein the first term comprises a Kullback-Leibler (KL) divergence, and the second term comprises a soft cross entropy.

4. The computer-implemented method of claim 1, further comprising performing one or more operations to augment the second data set based on one or more data augmentations.

5. The computer-implemented method of claim 1, wherein the first data set is associated with at least one task that is not included in the one or more tasks that the second machine learning model was previously trained to perform.

6. The computer-implemented method of claim 1, wherein the first data set is associated with at least one task that is included in the one or more tasks that the second machine learning model was previously trained to perform.

7. The computer-implemented method of claim 1, wherein performing one or more operations to generate the second data set comprises backpropagating one or more gradients to the first data set based on the one or more tasks that the second machine learning model was previously trained to perform.

8. The computer-implemented method of claim 1, wherein the first data set does not include random noise.

9. The computer-implemented method of claim 1, wherein the one or more operations to train the first machine learning model are further based on the first data set.

10. The computer-implemented method of claim 1, further comprising performing one or more tasks using the first machine learning model subsequent to performing the one or more operations to train the first machine learning model.

11. One or more non-transitory computer-readable media storing instructions that, when executed by at least one processor, cause the at least one processor to perform steps for training a first machine learning model having a different architecture than a second machine learning model, the steps comprising:
receiving a first data set;
performing one or more operations to generate a second data set based on the first data set and the second machine learning model, wherein the second data set includes at least one feature associated with one or more tasks that the second machine learning model was previously trained to perform; and
performing one or more operations to train the first machine learning model based on the second data set and the second machine learning model.

12. The one or more non-transitory computer-readable media of claim 11, wherein performing the one or more operations to train the first machine learning model comprises optimizing a loss function that includes a first term that minimizes a distance between an output of the first machine learning model and an output of the second machine learning model and a second term used to train the first machine learning model to perform one or more tasks that the second machine learning model was not previously trained to perform.

13. The one or more non-transitory computer-readable media of claim 12, wherein the first term comprises one of a Kullback-Leibler (KL) divergence, a mean squared error, or a Jensen-Shannon divergence.

14. The one or more non-transitory computer-readable media of claim 12, wherein the second comprises one of a cross entropy, a soft cross entropy, or a binary cross entropy.

15. The one or more non-transitory computer-readable media of claim 11, wherein the first data set is associated with at least one task that is included in the one or more tasks that the second machine learning model was previously trained to perform.

16. The one or more non-transitory computer-readable media of claim 11, wherein performing one or more operations to generate the second data set comprises backpropagating one or more gradients to the first data set based on the one or more tasks that the second machine learning model was previously trained to perform.

17. The one or more non-transitory computer-readable media of claim 11, wherein the first data set includes one or more images.

18. The one or more non-transitory computer-readable media of claim 11, wherein the one or more operations to train the first machine learning model are further based on the first data set.

19. The one or more non-transitory computer-readable media of claim 11, wherein the steps further comprise performing one or more tasks using the first machine learning model subsequent to performing the one or more operations to train the first machine learning model.

20. A system, comprising:
one or more memories storing instructions; and
one or more processors that are coupled to the one or more memories and, when executing the instructions, are configured to:
receive a first data set,
perform one or more operations to generate a second data set based on the first data set and a first machine learning model, wherein the first machine learning model has a different architecture than a second machine learning model, and the second data set includes at least one feature associated with one or more tasks that the first machine learning model was previously trained to perform, and
perform one or more operations to train the second machine learning model based on the second data set and the first machine learning model.
